(19) United States
(12) Patent Application Publication
(10) Pub. No.: US 2017/0364111 A1
(43) Pub. Date: Dec. 21, 2017

(54) LINEAR VOLTAGE REGULATOR

(71) Applicant: Infineon Technologies AG, Neubiberg (DE)

(72) Inventors: Marco Flaibani, Montegrotto (PD) (IT); Giovanni Bisson, Padova (IT); Marco Piselli, Padova (PD) (IT)

(21) Appl. No.: 15/188,855

(22) Filed: Jun. 21, 2016

(51) Int. Cl. G05F 1/575; H02M 3/04

(52) U.S. Cl. CPC G05F 1/575; H02M 3/04

(57) ABSTRACT

A circuit comprising a series voltage regulator comprising a first semiconductor device coupled in series between a supply voltage and a voltage output, the series regulator operable to receive a voltage level from the supply voltage and to provide a regulated voltage level at the voltage output; and a parallel voltage regulator comprising a second semiconductor device coupled to the voltage output, the parallel voltage regulator operable to detect a variation in a voltage level provided at the voltage output, and to sink and/or source a current from/to the voltage output through the semiconductor device, an amount of current sunk and/or sourced adequate to offset the change in the voltage level at the voltage output.

### TECHNICAL FIELD

This disclosure relates to linear voltage regulators.

### BACKGROUND

In electronic devices and in electrical power management systems, voltage regulation is a measure of the ability of a device or circuit, often referred to as a voltage regulator, to maintain a constant or near constant voltage output over a range of varying operating and load conditions. For smaller electronic devices, especially battery powered devices such as cellular phones and laptop computers, proper voltage regulation is critical to assure proper operation of the device. In addition, because battery life and time of operation between battery charges is important in these portable devices, power consumption of the circuits used to provide voltage regulation is also an important design consideration.

### SUMMARY

There is a great interest in efficient power management integrated circuits (ICs). An important building block in these power management systems is the low drop-out (LDO) linear regulator, which often follows a DC-DC switching converter. Linear voltage regulators, and in particular LDO linear regulators, are used to regulate the supplies ripples to provide a clean voltage source for the noise-sensitive analog/RF blocks often powered from these power management systems. As recognized herein, there is a need for a stable LDO linear regulator that operates over a wide range of load conditions, while achieving high power-supply rejection (PSR) or a high power supply rejection ratio (PSRR), along with a low drop-out voltage and high efficiency. The example implementations and techniques described in the present disclosure address both the efficiency problem and the accurate correction of the output voltage. In various examples, linear voltage regulators as described herein combine a series regulator with a parallel regulator to provide voltage regulation with a high power-supply rejection (PSR), along with a low drop-out voltage and high efficiency.

In one example, the disclosure is directed to a circuit comprising a series voltage regulator comprising a first semiconductor device coupled in series between a supply voltage and a voltage output, the series regulator operable to receive a voltage level from the supply voltage and to provide a regulated voltage level at the voltage output, and a parallel voltage regulator comprising a second semiconductor device coupled to the voltage output, the parallel voltage regulator operable to detect a variation in a voltage level provided at the voltage output, and to sink a current from the voltage output through the semiconductor device, an amount of current sunk adequate to offset the change in the voltage level at the voltage output.

In another example, the disclosure is directed to a method comprising receiving a supply voltage at an input of a series voltage regulator, regulating a voltage drop across a semiconductor device to provide a regulated voltage output at a voltage output of the series voltage regulator, receiving an indication of a voltage variation in the regulated voltage output, and in response to the variation in the regulated voltage output, sinking a current from the voltage output through a parallel voltage regulator in an amount that offsets the voltage variation at the voltage output.

In another example, the disclosure is directed to a circuit comprising a series voltage regulator comprising a first semiconductor device coupled in series between a supply voltage and a voltage output, the series regulator operable to receive a voltage level from the supply voltage and to provide a regulated voltage level at the voltage output, and a parallel regulator comprising a second semiconductor device coupled to the voltage output and a third semiconductor device coupled to the voltage output, wherein the parallel regulator is operable to detect a decrease in voltage level provided at the voltage output, and in response to the decrease in the voltage level, to source a first amount of current to the voltage output through the second semiconductor device, the first amount of current adequate to offset the decrease in the voltage level at the voltage output, and wherein the parallel regulator is operable to detect an increase in voltage level provided at the voltage output, and in response to the increase in the voltage level, to sink a second amount of current from the voltage output through the third semiconductor device, the second amount of current adequate to offset the increase in the voltage level at the voltage output.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example electrical system in accordance with one or more aspects of the present disclosure.

FIG. 2 is a schematic diagram illustrating a voltage regulator in accordance with one or more aspects of the present disclosure.

FIG. 3 is a block diagram illustrating a transfer function for an amplifier in a parallel voltage regulator in accordance with one or more aspects of the present disclosure.

FIG. 4A is a schematic diagram illustrating a voltage regulator in accordance with one or more aspects of the present disclosure.

FIG. 4B is a schematic diagram illustrating a voltage regulator in accordance with one or more aspects of the present disclosure.

FIG. 4C is a schematic diagram illustrating a voltage regulator in accordance with one or more aspects of the present disclosure.

FIG. 4D is a schematic diagram illustrating a voltage regulator in accordance with one or more aspects of the present disclosure.

FIG. 5 is a schematic diagram illustrating a voltage regulator in accordance with one or more aspects of the present disclosure.

FIG. 6 is a flowchart illustrating example methods in accordance with one or more aspects of the present disclosure.

The drawings and the description provided herein illustrate and describe various examples of the inventive methods, devices, and systems of the present disclosure. However, the methods, devices, and systems of the present disclosure are not limited to the specific examples as illustrated and described herein, and other examples and variations of the methods, devices, and systems of the present disclosure, as would be understood by one of ordinary skill in the art, are contemplated as being within the scope of the present application.

### DETAILED DESCRIPTION

For power management systems requiring voltage regulation, the needs for high efficiency of the system while keeping a clean supply at high frequency is becoming more and more important in many segments. When using linear voltage regulators to provide voltage regulation, one simple procedure to increase the efficiency of the linear regulators while keeping a good PSR or PSRR is to reduce the drop voltage in the pass element of the linear regulator to a minimum. However, as recognized herein, this approach requires large power stages. In addition, the trend in electronics is toward larger amounts of current to be delivered to loads, such as analog and RF circuit blocks, which also implies using bigger and bigger power transistors for the linear regulators.

In addition, the efficiency of the linear voltage regulator, specifically a LDO linear voltage regulator, could be calculated using the following formula:

$$η = \frac{{V}_{out} {I}_{out}}{{V}_{in} {I}_{out} + {V}_{in} {I}_{quiescent}} ∼ \frac{{V}_{out}}{{V}_{in}}$$

wherein η is the efficiency of the voltage regulator that can be expressed in percentage, Vout is the output voltage provided from the voltage regulator, Tout is the current provided as an output from the voltage regulator, Vin is the input voltage provided to the voltage regulator and Iquiescent is the current consumed by the voltage regulator in the process of regulating the output voltage.

One procedure to improve performance of the power transistor is to keep the power transistor at the border between triode and saturation region (for Metal-Oxide Semiconductor (MOS) devices). In this way, is possible to have the advantage of the “high” PSR while keeping the efficiency at a maximum. Unfortunately, this approach quite quickly results in an “unreasonable” power sizing. The evidence of this could be found in the region MOS equation of the border region between triode and saturation. This point could be express in with the following formula:

$${V}_{DS} = {V}_{GS} - {V}_{th} \to {I}_{d} = \frac{1}{2} {μ}_{n} {C}_{ox} \frac{W}{L} {( {V}_{DS} )}^{2}$$

Wherein Vds is drain source voltage of a MOS (that is the drop of the power MOS)
Vth is the threshold voltage of the MOS
Id is drain current of the MOS
μₙ is the electron effective mobility
Cox is the gate oxide capacitance per unit area
W is the gate width of the MOS transistor
L is the gate length of the MOS transistor
   This allow for a simple verification that for a given technology, by reducing the drop across the pass element to half the drop, the reduction will result in an increase in the W/L ratio of the element of 4 times (means 4 times the area with fixed L, usually minimum L for a power stage), while a doubling of the current will be required to double the power stage area.

Many different approaches have been used to increase PSR of the LDO linear voltage regulator. Examples include: using simple RC filtering at the output of the LDO linear voltage regulator, cascading two regulators, cascading another transistor with the pMOS pass transistor along with RC filtering, using special technologies such as drain-extended FET devices, and/or charge-pump techniques to bias the gate of one of the transistors.

However, as recognized herein, simple RC filtering reduces the voltage ripple at the input of the LDO but this technique increases the drop-out voltage in LDO regulators that supply high current due to the high voltage drop across the resistance. Using an nMOS or pMOS transistor to cascade with the pMOS pass transistor can achieve high power supply rejection over a wide frequency range. However, as recognized herein, these techniques increase the area required and lead to a high drop-out voltage. Further, charge pump techniques may increase complexity and lead to higher power consumption because a clock is necessary along with RC filtering to remove clock ripples. In summary, the main idea behind these techniques is to provide more isolation between the input and output along the high-current signal path. Hence, the area consumption and drop-out voltage are large.

Recently, a new approach called feed-forward ripple cancellation has been put forward. This approach requires taking into consideration the output impedance of the MOS device and tries to correct this “leakage” current with a proper open-loop modulation of the gate source voltage. As recognized herein, the main disadvantages of these techniques are that they are based on knowing the output impendence of the power MOS device, while this value could change significantly with load current and process spread.

Thus, all these techniques to improve the PSR of the LDO regulators rely on a high drop regulator, or rely on an open loop correction, which fails to provide good control of the PSR over load changes and over production spread. The example implementations and techniques provided in the present disclosure address both the efficiency problem and the accurate correction of the output voltage. The main idea is to combine a serial voltage regulation with parallel voltage regulation.

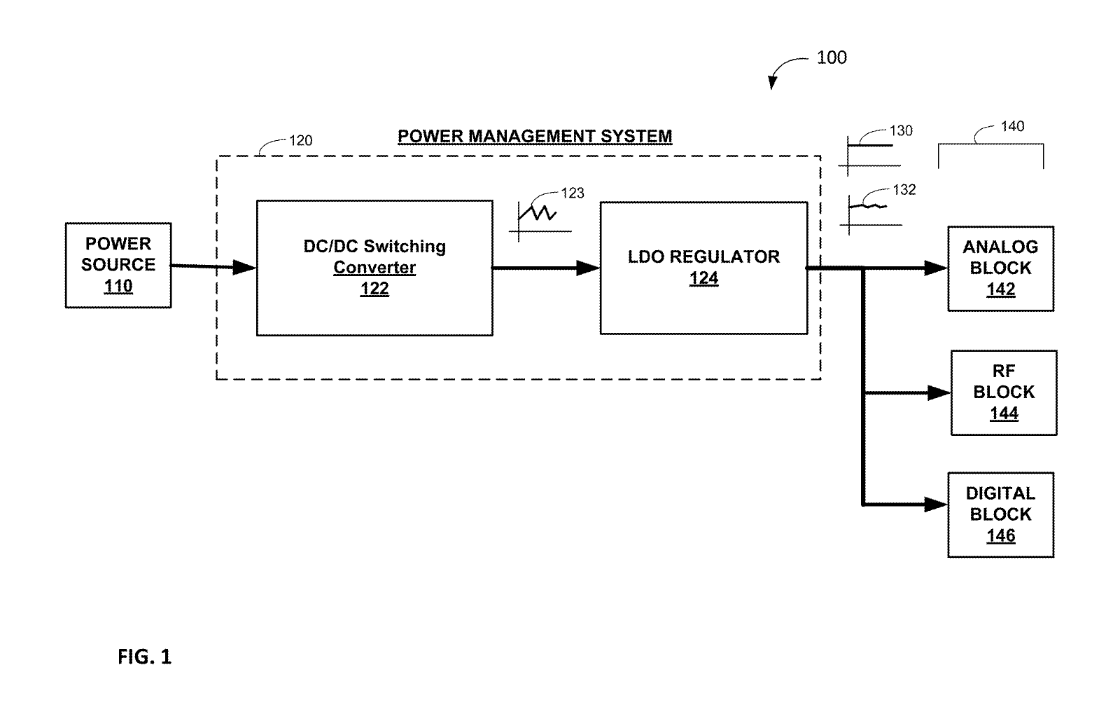

FIG. 1 is a block diagram illustrating an example electrical system 100 in accordance with one or more aspects of the present disclosure. As illustrated, electrical system 100 includes a power source 110 having a power output coupled to an input to power management system 120. Power management system 120 includes an output coupled to one or more loads 140. In various examples, power source 110 is operable to provide electrical power to the input of power management system 120. Power source 110 is, in some examples, a battery operable to provide electrical power at a particular direct current (DC) voltage level. In various examples, loads 140 require power from a voltage supply having a voltage level that is different from the voltage provided by power source 110. In order to generate this difference in voltage levels, power management system 120 includes a DC/DC switching converter 122 that is operable to receive, as an input from power source 110, electrical power at the voltage level provided by power source 110, and to convert the received electrical power into a direct current electrical power output having a voltage level that is different, either higher or lower, than the voltage level received from power source 110.

The output electrical power provided by converter 122 is shown graphically as output 123. As shown in output 123, the converter 122 provides a direct current output that includes some variation (noise) in the output voltage level. This level of noise, as present at the output of converter 122, could have adverse effects on the operation of loads 140 if provided to these loads directly from the output of converter 122. For example, the noise present in output 123, if provided as the supply voltage to the analog block 142, radio frequency block 144, or the digital circuit block 146 shown in FIG. 1 as examples of loads 140, could cause these blocks to operate improperly, or to not function at all for their intended purposes. In order to reduce or eliminate this noise, the output of converter 122 is coupled to an input of a LDO voltage regulator 124. As shown in FIG. 1, the output of regulator 124 ideally provides electrical power having an output shown graphically as output 130, which has no noise present in the output. In some examples, output 132 illustrates a graphical representation of the actual output from regulator 124, wherein the output from regulator 124 has some level of variation in the output voltage level representing noise, but at a level of noise that is much less than the level of noise present at the output of converter 122. The output electrical power provided by regulator 124 is coupled to loads 140, and provides a supply voltage for loads 140 at a voltage level required by these load, and with a noise level that is below a level that would cause these load to not function properly.

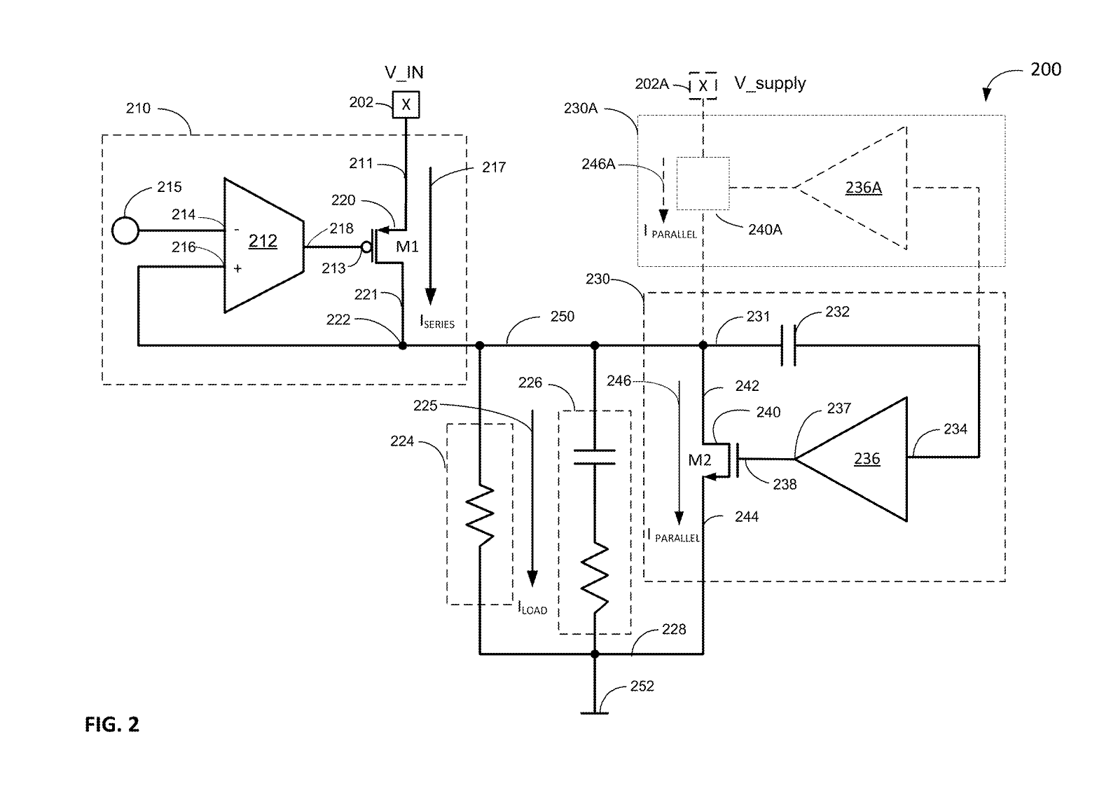

FIG. 2 is a schematic diagram illustrating a voltage regulator 200 in accordance with one or more aspects of the present disclosure. As illustrated, voltage regulator 200 includes a both a series regulator 210 and a parallel regulator 230, operable to be coupled to a load, such as but not limited to illustrative load 224. As illustrated in FIG. 2, series regulator 210 is coupled to a voltage input (V_IN) 202. In various examples, a voltage provided by voltage input 202 is a voltage that is operable to be regulated by series regulator 210 and parallel regulator 230, and coupled as illustrated in FIG. 2 to supply a regulated voltage to load 224. In various examples, voltage regulator 200 is LDO regulator 124 as shown in FIG. 1, although examples of voltage regulator 200 are not limited to regulator 124. In various examples, load 224 is illustrative of any of loads 140 as shown in FIG. 1, although examples of loads that might comprise load 224 are not limited to loads 140.

As illustrated in FIG. 2, series regulator 210 includes P-type semiconductor device (M1) 220 having a first lead (input) 211 coupled to voltage input 202, a second lead 221 coupled to node 222, and a gate 213. Series regulator 210 further includes an amplifier 212 having a non-inverting input 216 coupled to node 222, an inverting input 214 coupled to a reference voltage 215, and an output 218 that is coupled to gate 213 of semiconductor device 220. Node 222 of series regulator 210 is coupled to output node 250. In various examples, series regulator 210 is operable to receive a supply voltage from voltage input 202, and to provide series regulation of the voltage input through semiconductor device 220 in order to provide a regulated voltage output to node 250, as further described below. In various examples, semiconductor device 220 is referred to as the “pass element” of series regulator 210. The pass element included in series regulator 210 is not limited to comprising a P-type semiconductor device, and can comprise any type of semiconductor device that is configurable to operate as the pass device for a low-dropout voltage regulator.

Voltage regulator 200 also includes a parallel regulator 230. Parallel regulator 230 includes a semiconductor device (M2) 240 having a first lead 242 coupled to node 231, a second lead 244 coupled to reference voltage 252, and a gate 238. In various examples, reference voltage 252 may be referred to as “ground” voltage. However, reference to “ground” or to a voltage level of “ground” is not limited to any particular voltage level, or to specifically meaning “earth ground”, and is to be interpreted as referring to a common voltage level between points designated as being coupled to “ground” or as being “grounded”. As illustrated, node 231 is coupled to output node 250. Parallel regulator 230 further includes a capacitor 232 having a first terminal coupled to node 231, and a second terminal coupled to an input 234 of amplifier 236. Amplifier 236 includes an output 237 coupled to gate 238 of semiconductor device 240. In various examples, parallel regulator 230 is operable to sink a current flow (I_{PARALLEL}) 246 from output node 250 to reference voltage 252, providing a bypass route for a current path from output node 250 through the load 224 to reference voltage 252, and thus providing addition voltage regulation to the voltage provided to load 224 at output node 250, and further described below.

In various examples, voltage regulator 200 includes illustrative output capacitive element 226, comprising an illustrative capacitor and an equivalent series resistance of the illustrative capacitor. In various examples, output capacitive element 226 is provided as a capacitive coupling between output node 250 and reference voltage 252 to provide additional filtering and stability to the output voltage provided at output node 250, and thus to load 224.

In operation, a voltage provided by at voltage input 202 provides a current flow 217 (I_{SERIES}) through semiconductor device 220 to node 222. Due to the extremely high input impedance of non-inverting input 216 of amplifier 212, substantially the entire current flow 217 passing through semiconductor device 220 is provided to node 222 and to output node 250. The voltage at node 222 is provided as feedback to the non-inverting input 216 of amplifier 212. Amplifier 212 receives a reference voltage at the inverting input 214 from reference voltage 215, and is operable to provide an output voltage at output 218 that when provided to gate 213 of semiconductor device 220, causes semiconductor device 220 to regulate the current flow 217 through semiconductor device 220, providing a voltage drop across semiconductor device 220 that varies so that the voltage provided at node 222 is less than the voltage provided at input 211, and comprising a regulated voltage level that includes less voltage variations (e.g., is better regulated with respect to voltage level), than the voltage provided at input 211. The voltage provided at node 222 is coupled to output node 250. This voltage as provide at output node 250 is provided to load 224. The current flow 217 through semiconductor device 220 and leaving node 222 is therefore provided to output node 250. As such, at least some portion of current flow 217 is provided to load 224 and capacitive element 226, represented by current flow (I_{LOAD}) 225 shown in FIG. 2 as flowing from output node 250 through load 224 to reference voltage 252. At times a portion of current flow 217 may also be directed to output capacitive element 226.

In addition, the voltage provided at output node 250 is also provided to node 231 of parallel regulator 230, and thus is coupled though capacitor 232 to the input 234 of amplifier 236. Based on this input to amplifier 236, amplifier 236 is operable to provide control signal at output 237 that is provided to the gate 238 of semiconductor device 240. The control signal provided to gate 238 controls semiconductor device 240 to regulate the current flow (I_{PARALLEL}) 246 from node 231 through semiconductor device 240 to reference voltage 252. At times, regulation of the current flow 246 through semiconductor device 240 includes allowing no current flow through semiconductor device 240. At other times, regulation of the current flow 246 through semiconductor device 240 includes controlling an amount of current allowed to flow through semiconductor device 240 based on the output signal provided by amplifier 236 to the gate 238 of semiconductor device 240. When semiconductor device 240 is regulated so that no current is flowing from node 231 though semiconductor device 240 to reference voltage 252, substantially all the current flow 217 provided from series regulator 210 to output node 250 is available to flow through load 224. In the alternative, when semiconductor device 240 is regulated by amplifier 236 so as to allow a current flow 246 from node 231 through semiconductor device 240 to reference voltage 252, any current flowing through semiconductor device 240 is no longer available to flow through load 224, and thus increases the total amount of current flow 217 needed to be provided from series regulator 210 to output node 250 in order satisfy the current requirements of the load 224. The increase in current flow is provided by an increase in the current flow 217 through semiconductor device 220, resulting in a larger voltage drop across semiconductor device 220 (functioning as the pass element), and thus a lowering of the output voltage provided at output node 250. In various examples, variations in the voltage level at output node 250 are provided to amplifier 236 through capacitor 232. Based on the indication of these variations in the voltage level received at the input of amplifier 236, amplifier 236 is operable to provide the control signal at output 237 that controls semiconductor device 240 so that the amount of current flow 246 flowing through semiconductor device 240 offsets the change in the voltage level provided at output node 250 by altering the total amount of current flow 246 flowing through semiconductor device 240, and thus affecting the total amount of current flow 217 that is flowing through semiconductor device 220. By varying the current flow 217 through semiconductor device 220, parallel regulator 230 is operable to offset variations in the voltage provided at output node 250.

In various examples, an increase in the voltage level at output node 250 is received at input 234 of amplifier 236 through capacitor 232. In general, this increase in voltage level results from a lower level of current flowing 225, through the load thus, resulting in a smaller voltage drop across semiconductor device 220. In some examples, this voltage increase is a result of noise not completely removed by series regulator 210, and arriving at output node 250. In response to the increase in voltage level at output node 250, amplifier 236 is operable to provide a control signal to bias the gate 238 of semiconductor device 240 so that semiconductor device 240 allows or increases a current flow 246 to sink current from node 231, and thus from output node 250, to reference voltage 252. This increase in current flow 246 from output node 250 is in addition to any current flow 225 provided to load 224, and thus increases the current flow 217 through semiconductor device 220 of series regulator 210. The increase current flow 217 through semiconductor device 220 caused a larger voltage drop to occur across semiconductor device 220, thus reducing the voltage level provided by series regulator 210 at output node 250. In effect, the increase in voltage at output node 250 can be offset or eliminated by sinking the current flow 246, thus providing better voltage regulation at output node 250 relative to voltage increases.

In various examples, a decrease in the voltage level at output node 250 is received at input 234 of amplifier 236 through capacitor 232. In general, this decrease in voltage level results from a higher level of current flowing 225 through the load, thus generating a larger voltage drop across semiconductor device 220. In some examples, this voltage decrease at output node 250 is a result of noise not completely removed by series regulator 210, and arriving at output node 250. In response to the decrease in the voltage level at output node 250, amplifier 236 is operable to provide a control signal to bias the gate 238 of semiconductor device 240 so that semiconductor device 240 stops sinking or decreases an amount of a current flow 246 that is being sunk from node 231 through semiconductor device 240 to reference voltage 252. This decrease in the current flow 246 being sunk from output node 250 results in a lower overall level of current flow being provided from series regulator 210, and thus decreases the current flow 217 through semiconductor device 220 of series regulator 210. The decrease in current flow 217 through semiconductor device 220 caused a smaller voltage drop to occur across semiconductor device 220, thus increasing the voltage level provided by series regulator 210 at output node 250. In effect, the decrease in voltage at output node 250 can be offset or eliminated by decreasing the amount of current flow 246 being sunk from output node 250 by parallel regulator 230, thus providing better voltage regulation at output node 250 relative to voltage decreases.

By providing parallel regulator 230 coupled in parallel to the load 224 for which series regulator 210 is providing a regulated output voltage to, a much higher PSR can be achieved for regulation of the output voltage at output node 250. In addition, even though the parallel regulator 230 does consume some level of current in the process of regulating the output voltage, the current flow 246 is very small relative to the current flow 225 provided to load 224, and therefore the change (loss) in the level of efficiency for voltage regulator 200 by the use of parallel regulator 230 is also very minimal. By way of example, for a configuration wherein the input voltage at voltage input 202 (Vin) is 4 V, the output voltage level at output node 250 (Vout) is 3.3 V, the load current provided to load 224 (I_{LOAD) is} 1 A, and the quiescent current consumed by voltage regulator 200 (Iquiescent) of 500 μA, the efficiency of voltage regulation without parallel regulator 203 is calculated as:

$$η = \frac{{V}_{out} {I}_{out}}{{V}_{in} {I}_{out} + {V}_{in} {I}_{quiescent}} = 82.46 \%$$

With the addition of parallel regulator 230 and a current flow 246 consumption of Iₛₕᵤₙₜ=5 mA, the efficiency of the voltage regulator 200 with parallel regulator 230 is calculated as:

$$η = \frac{{V}_{out} {I}_{out}}{{V}_{in} {I}_{out} + {V}_{in} {I}_{quiescent} + {V}_{out} {I}_{shunt}} = 82.12 \%$$

Thus, even with quite high current consumption of the current flow 246 due to the high current required by the load 224, the loss in the efficiency by the addition of parallel regulator 230 is extremely small, e.g., less than one half of one percent. In addition, the slight loss in efficiency provides an improvement in the PSR of the voltage regulator even at high frequencies. If the configuration illustrated above is changed, for example to reduce the input voltage by just 200 mV, while keeping the previous performances in term of PSR, the new calculation with Vin=3.8 V will give a new efficiency of:

$$η = \frac{{V}_{out} {I}_{out}}{{V}_{in} {I}_{out} + {V}_{in} {I}_{quiescent} + {V}_{out} {I}_{shunt}} = 86.42 \%$$

wherein I shunt is the current shunt through the parallel voltage regulator and bypassing the load. Thus, overall the efficiency of the voltage regulator 200 is actually improved, while still gaining the benefit of the keeping the same PSR at higher frequency ranges, all by the addition and operation of the parallel regulator 230. In addition to these efficiencies and PSR improvements, the parallel regulator 230 also suppress noise coming back from the load due to its ability to decrease the impedance of the series regulator 210 over a wider range of frequencies.

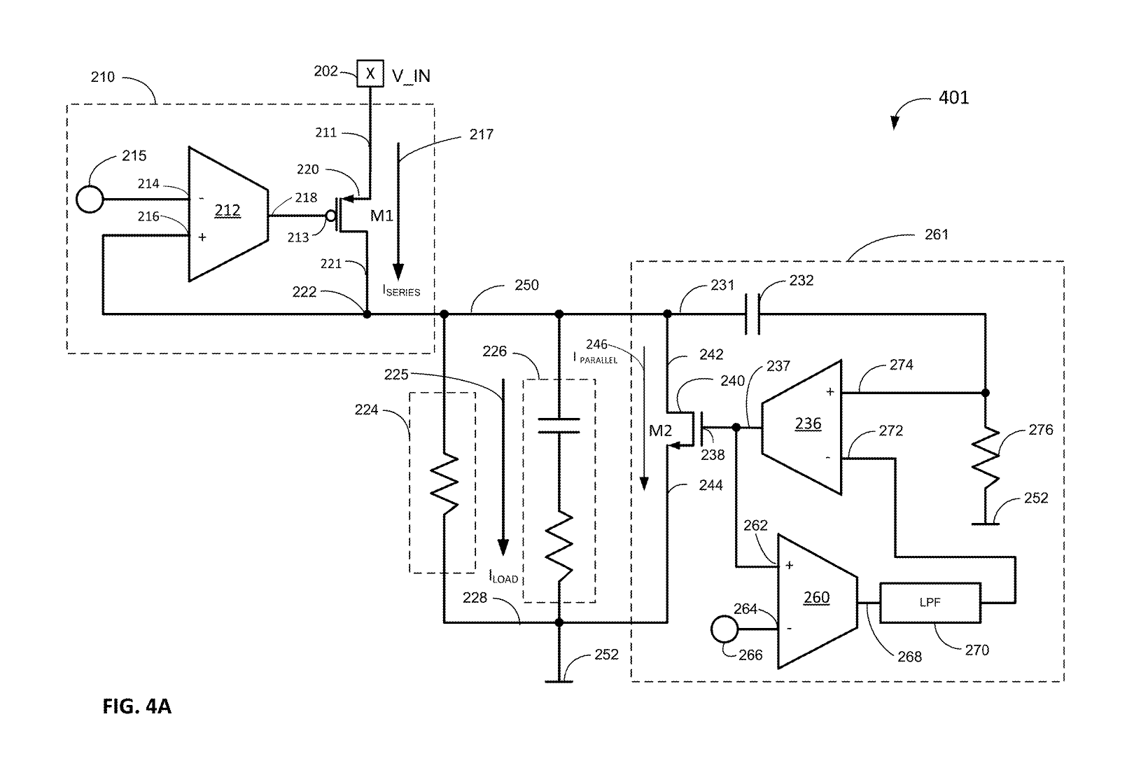

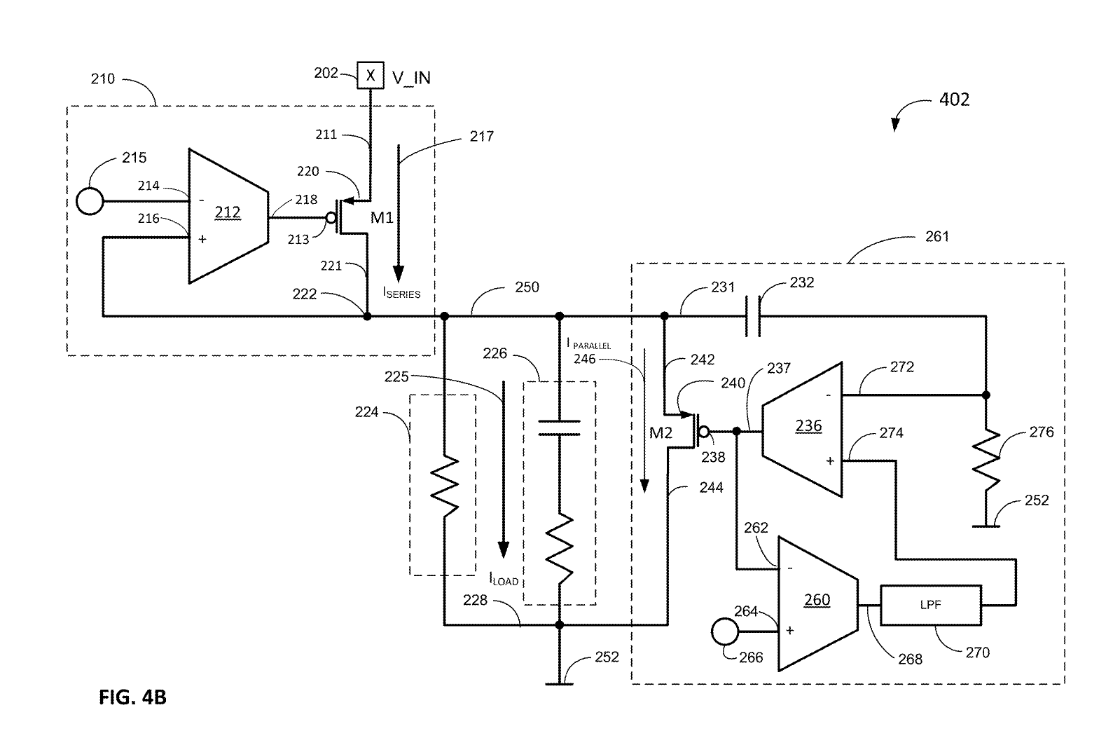

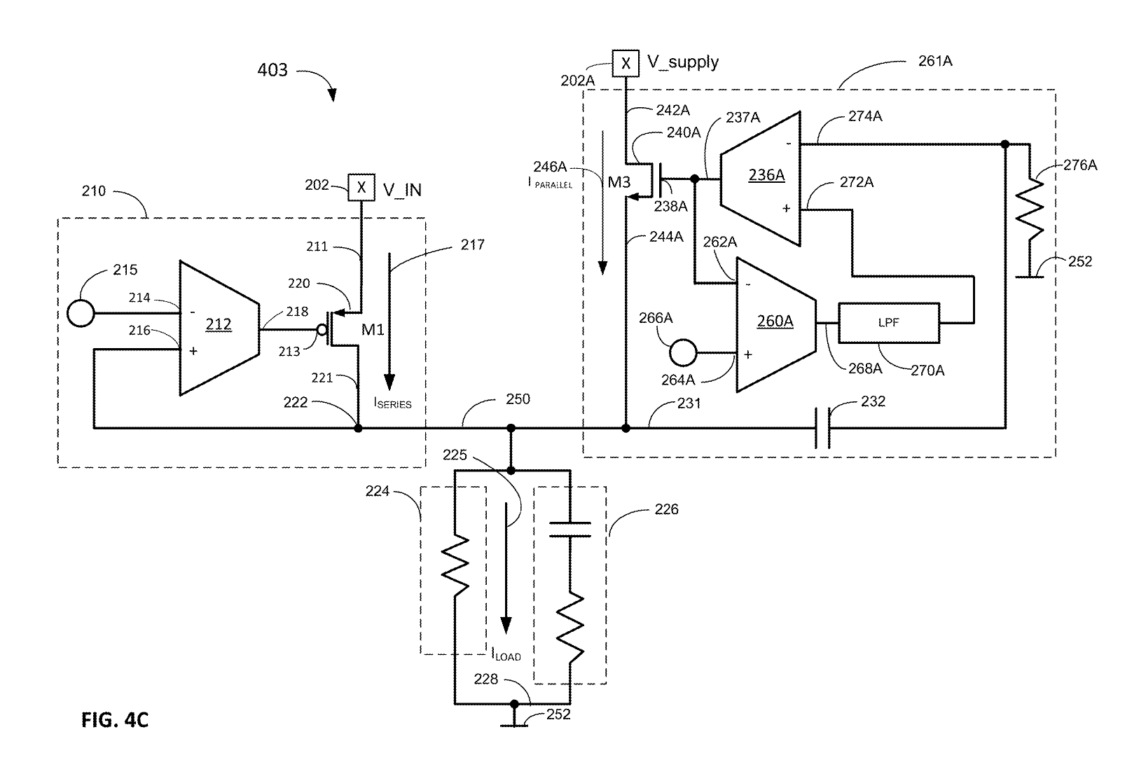

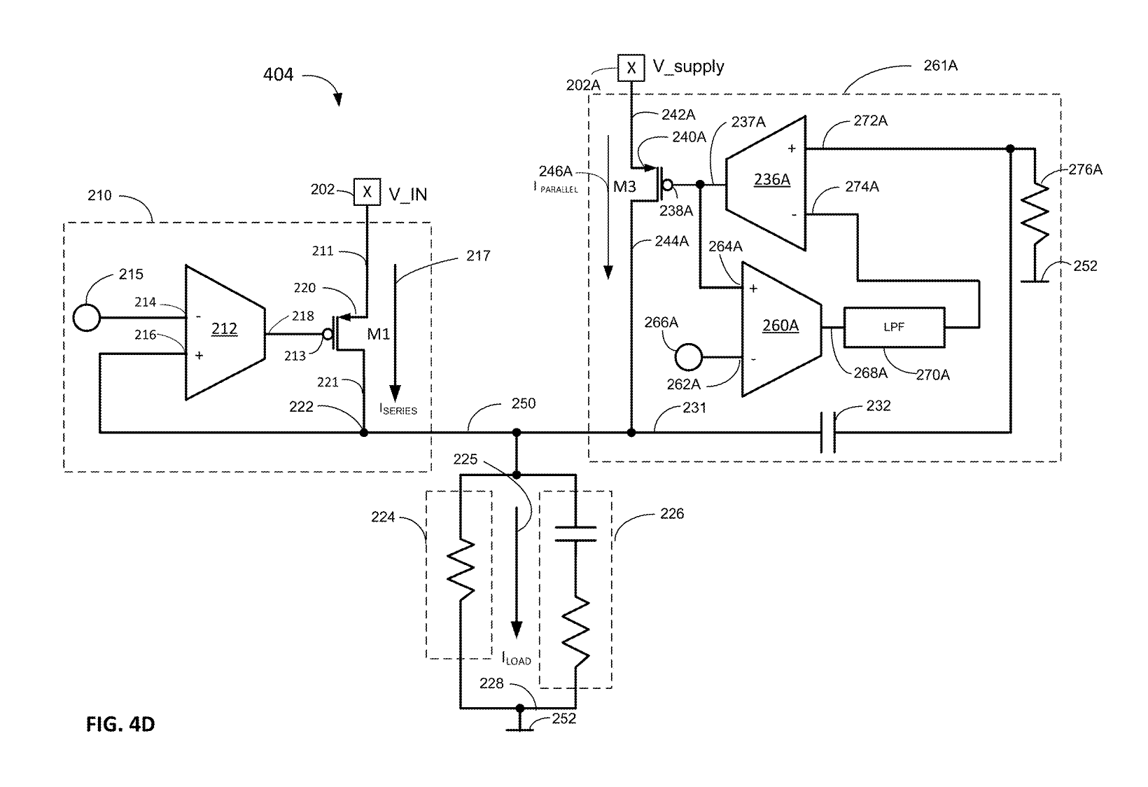

As shown in FIG. 2, semiconductor device 240 is an N-type semiconductor device. In such examples, amplifier 236 can be coupled as a non-inverting amplifier, wherein input 234 coupled to capacitor 232 is also coupled to a non-inverting input of amplifier 236, for example as further illustrated in FIG. 4A. However, in various examples semiconductor device 240 can be a P-type semiconductor device, and amplifier 236 is configured as an inverting amplifier, for example as illustrated in FIG. 4B. Further, it would be understood by one of ordinary skill in the art that polarity of parallel regulator 230 could be flipped by replacing the N-type semiconductor device 240 with a P-type semiconductor device, and coupling the P-type semiconductor device between a supply voltage (V_supply) 202A, such as but not limited to voltage input 202, and node 231. Such an example is illustrated by amplifier 236A and semiconductor device 240A comprising voltage regulator 230A as shown in FIG. 2. In this configuration, the P-type voltage regulator would be operable to control an amount of current flow (I_{PARALLEL}) 246A sourced to node 231, and thus to output node 250, based on input received through capacitor 232 provided to amplifier 236A, having amplifier 236A coupled to the gate of semiconductor device 240A and operable to control the P-type semiconductor device 240A. By regulating the amount of current flow 246A sourced from a supply voltage (V_supply) 202A through the P-type semiconductor device to output node 250, voltage regulator 230A would be operable to provide parallel regulation of the output voltage provided to output node 250 from series regulator 210. An example of a voltage regulator 230A is further illustrated and described below with respect to FIG. 4C. In addition, semiconductor device 240A can also be a N-type semiconductor device, wherein an example of voltage regulator 230A comprising an N-type semiconductor device 240A is further illustrated and described below with respect to FIG. 4D.

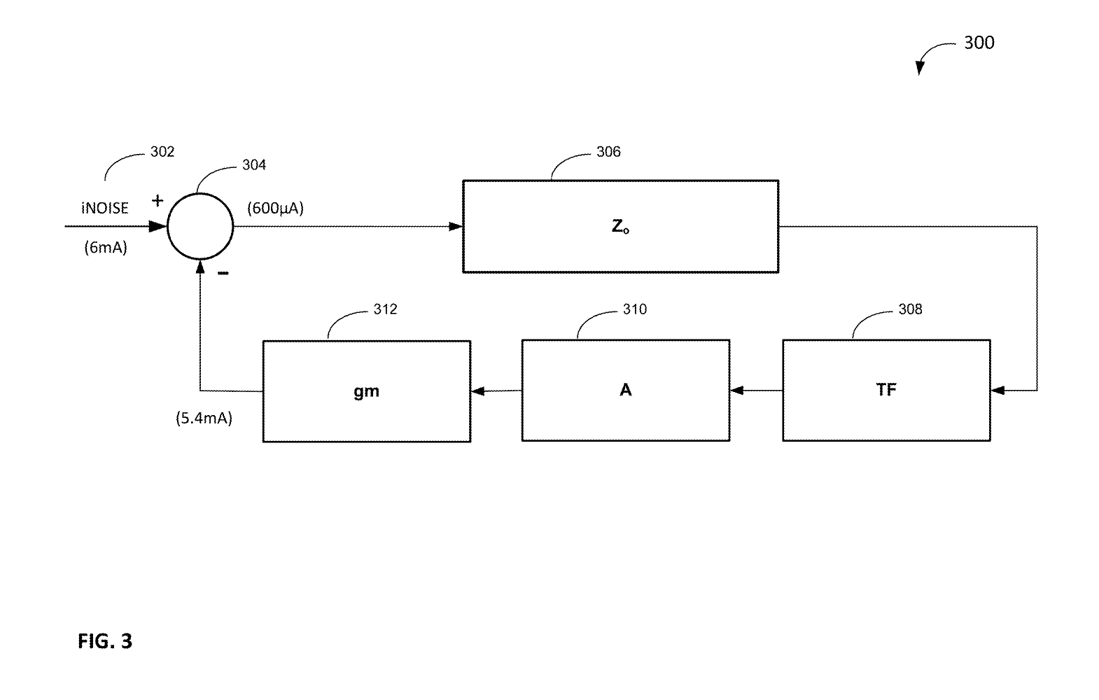

FIG. 3 is a block diagram 300 illustrating a transfer function for an amplifier in a parallel voltage regulator in accordance with one or more aspects of the present disclosure. For a parallel voltage regulator, such as parallel regulator 230 as shown in FIG. 2, the semiconductor device 240 should be biased with enough DC current in order to suppress the variations in the output voltage, such as “noise” present at the voltage output node 250. This biasing could be calculating assuming a ripple at the input of the series regulator 210, a known capacitance value for output capacitive element 226, and the performance of the regulator. For example, an illustrative configuration is provided as follows: conventional regulator at 100 kHz has 40 dB at 1 A load, with an output capacitive element 226 of 10 μF and an input peak-to-peak voltage ripple value of 100 mV. The output impedance of the capacitor (with no ESR effect) could be calculated as follow:

$$\vert {Z}_{o} \vert = \frac{1}{2 π fC} = 159 m Ω$$

|.| is the module of a complex number, Zo said output impedance, f=frequency (said 100 kHz), C output capacitance value (said 10 uF)

With respect to load impedance, and supposing it is a resistance, is equal to: 3.3V/1 A=3.3 Ohms. Under this configuration, the entire ripple in the output voltage is determined by the output capacitance. The “noise” current coming from the LDO voltage regulator could be calculated as:

$$iNoise = \frac{{V}_{in \text{-} noise}}{PSR \vert {Z}_{o} \vert} ∼ 6 mA$$

iNoise as below (noisy current coming from traditional regulator, PSR power supply rejection, Zo as above, Vin-noise input noise in volt

With a target to improve the PSR set at 20 dB at 100 kHz and with the support of the block diagram 300, an estimate of the needed gain for the amplifier 236 can be made. Where iNoise 302 is the noisy current coming from the traditional regulator, TF 308 is the possible transfer function of the filter, A 310 is the gain of the amplifier 236, and gm 312 is the transconductance of the semiconductor device 240. Making the assumption that TF=1, the shunt loop is in the bandwidth of operation and the gm of the semiconductor device 240 is:

$$gm = \frac{2 {I}_{d}}{{V}_{ov}} = \frac{2 * 6 m}{0.35} ∼ 40 mS$$

Zo said output impedence, circle 304 is a summing (with sign) node of two quantities, means 6 mA-5.4 mA (input quantities)=0.6 mA (output quantity) From the block diagram 300 above it can be shown that:

(iNoise−iReduction)*Zₒ*TF*A*gm=5.4 mA→A=1500

Or for 40 dB PSR improvement:

(iNoise−iReduction)*Zₒ*TF*A*gm=5.94 mA→A=15000

iNoise (noisy current coming from the regulator, Zo as above, TF as above, A as above, gm as above, iReduction is the signal coming from block 312 (fig.3)

FIG. 4A is a schematic diagram illustrating a voltage regulator 401 in accordance with one or more aspects of the present disclosure. As illustrated in FIG. 4A, elements that have been illustrated in previous figure(s) retain the same reference number used in the previous figure(s). As shown in FIG. 4A, load 224, output capacitive element 226, and series regulator 210, including amplifier 212 and semiconductor device (M1) 220, are all coupled to output node 250 as illustrated and described above with respect to FIG. 2. As previously described for example with respect to FIG. 2, series regulator 210 is operable to provide voltage regulation to output node 250 and load 224 using the voltage provided by voltage input (V_IN) 202.

In addition, voltage regulator 401 includes parallel regulator 261 coupled to output node 250. As illustrated, parallel regulator 261 includes capacitor 232, a N-type semiconductor device (M2) 240, a first amplifier 236, a second amplifier 260, a low pass filter 270, and a resistor 276. A first lead of capacitor 232 is couple to output node 250 through node 231, and a second lead of capacitor 232 is coupled to a non-inverting input 274 of first amplifier 236. First amplifier 236 includes an inverting input 272, and an output 237. Resistor 276 includes a first lead coupled to the non-inverting input 274 of first amplifier 236, and a second lead coupled in some examples to reference voltage 252, or some other reference voltage level. Output 237 of first amplifier 236 is coupled to the gate 238 of semiconductor device (M2) 240. Semiconductor device 240 includes a first lead 242 coupled to node 231, and a second lead 244 coupled to reference voltage 252. Output 237 of first amplifier 236 is also coupled to the non-inverting input 262 of second amplifier 260. Second amplifier 260 includes an inverting input coupled to voltage reference 266, and an output 268. Output 268 of second amplifier 260 is coupled to an input of low pass filter (LPF) 270. The output from low pass filter 270 is coupled to the inverting input 272 of first amplifier 236.

In voltage regulator 401, series regulator 210 performs the functions described above with respect to FIG. 2, by providing series regulation of the voltage input 202 to provide a regulated voltage output at output node 250. In addition, in a manner similar to that described above with respect to FIG. 2, in FIG. 4A the first amplifier 236 is operable to provide a control signal at output 237 to gate 238 to control semiconductor device 240. In controlling semiconductor device 240, control of the current flow 246 allows parallel regulator 261 to further regulate the voltage at output node 250, and to reduce or eliminate noise included in the voltage provided by series regulator 210 to output node 250.

The addition of second amplifier 260 and low pass filter 270 is operable to provide control of a DC bias level at the gate 238 of semiconductor device 240. In operation, second amplifier receives a reference voltage provided by voltage reference 266, and forces the reference voltage to be provided as a DC bias offset to the gate voltage being applied to gate 238 of semiconductor device 240. In some examples, the DC bias level is set to the threshold voltage level for semiconductor device 240. In some examples, the DC bias level is linked to the noise level that is supposed to be present in the voltage input 202. In some examples, the DC bias level is linked to a level of noise present in the voltage at output node 250.

Low pass filter 270 is operable to avoid degradation of the performance of parallel regulator circuit 261. In various examples, low pass filter 270 is operable to allow high frequency signals to be propagated from output 237 of first amplifier 236 to the gate 238 of semiconductor device 240, while maintaining a same DC bias level at semiconductor device 240.

In various examples, a transfer function of first amplifier 236 can be expresses as:

$$tf \text{:} \frac{A}{1 + AB} = \{ \begin{matrix}\frac{1}{B} for low freq \to AB ≫ 1 \\ A for high freq \to AB ≪ 1\end{matrix}$$

wherein “A” represents a gain first amplifier 236, and “B” represents a gain of second amplifier 260.

In various examples, a simple calculation could be used to estimate the frequency of the low pass filter. In various examples, the loop made by first amplifier 236+second amplifier 260+low pass filter 270 should have no gain (−20 dB) in the frequency of interest (for example 100 kHz), and second amplifier 260 could be designed to have a DC gain only of 20 dB. If both first amplifier 236 and second amplifier 260 do not have an additional pole until 100 kHz, the gain bandwidth product will remain constant as:

0.1*100 kHz=A*B*fₚ₁→fₚ₁=0.7 Hz

wherein fₚ₁ is the frequency of the first pole to be calculated. Thus, parallel regulator 261, when used in conjunction with a series regulator, such as but not limited to series regulator 210, provides the advantage of allowing the circuit designer to set a DC bias level for semiconductor device 240 by selecting and/or controlling the reference voltage provided by voltage reference 266, while maintaining all the performance benefits of voltage regulation provided by the parallel regulator at higher frequencies.

FIG. 4B is a schematic diagram illustrating a voltage regulator 402 in accordance with one or more aspects of the present disclosure. The voltage regulator 402 is similar to the voltage regular 401 as shown in FIG. 4A, with the following differences. In voltage regulator 402 as shown in FIG. 4B, semiconductor device 240 comprises a P-type semiconductor device having a first lead 242 coupled to node 231, and a second lead 244 coupled to reference voltage 252. In addition, in voltage regulator 402, the inverting input 272 of amplifier 236 is coupled to capacitor 232 and resistor 276, and the non-inverting input 274 of amplifier 236 is coupled to receive the output from low pass filter 270. Also the amplifier 260 has the inverting input connected to the gate 238 while the non-inverting input is connected to reference 266. In other respects, voltage regulator 402 operates as described above with respect to voltage regulator 401, wherein amplifier 236 is configured to receive in input from output node 250 through capacitor 232, and to provide a control signal at output 237 to regulate semiconductor device 240. Control of semiconductor device 240 provides control of the current flow (I_{PARALLEL}) 246, and thus allows parallel regulator 261 to further regulate the voltage at output node 250, and to reduce or eliminate noise included in the voltage provided by series regulator 210 to output node 250. Voltage regulator 402 is also configured to provide the features and benefits described above related to low pass filtering through incorporation of second amplifier 260 and low pass filter 270.

In other examples, the polarity of voltage regulator 261 could be flipped by replacing semiconductor device 240 with a semiconductor device coupled between a supply voltage, such as but not limited to voltage input 202, and node 231. In this configuration, the parallel voltage regulator would be operable to control an amount of current sourced to node 231, and thus to output node 250, based on input received through capacitor 232 provided to an amplifier, such as amplifier 236, having amplifier 236 coupled to the gate of the semiconductor device, and operable to provide a control signal to control the semiconductor device in a manner described above for semiconductor device 240. By regulating the amount of current sourced from a supply voltage through the semiconductor device to output node 250, a parallel regulator configured with a semiconductor device coupling a supply voltage to output node 250 would be operable to provide parallel regulation of the output voltage provided to output node 250 from series regulator 210. In various examples of this configuration, a second amplifier and a low pass filter can be coupled to the first amplifier, as described above, to provide the DC biasing for the semiconductor device. Examples of such circuits are described below with respect to FIGS. 4C and 4D.

FIG. 4C is a schematic diagram illustrating a voltage regulator 403 in accordance with one or more aspects of the present disclosure. As shown in FIG. 4C, devices and circuit elements that correspond to devices and circuit elements illustrated in FIG. 4A have been labeled with a corresponding reference number, but with an added “A” as a suffix to the corresponding reference number. As shown in FIG. 4C, voltage regulator 403 includes parallel regulator 261A coupled to output node 250. As illustrated, parallel regulator 261A includes capacitor 232, a N-type semiconductor device (M3) 240A, a first amplifier 236A, a second amplifier 260A, low pass filter 270A, and resistor 276A. A first lead of capacitor 232 is coupled to output node 250 through node 231, and a second lead of capacitor 232 is coupled to the inverting input 274A of first amplifier 236A. First amplifier 236A includes the non-inverting input 272A, and an output 237A. Resistor 276A includes a first lead coupled to the inverting input 274A of first amplifier 236A, and a second lead coupled to reference voltage 252, but not limited to it. Output 237A of first amplifier 236A is coupled to the gate 238A of semiconductor device (M3) 240A. Semiconductor device 240A includes a first lead 242A coupled to a supply voltage (V_supply) 202A, and a second lead 244A coupled to node 231. Output 237A of first amplifier 236A is also coupled to the inverting input 262A of second amplifier 260A. Second amplifier 260A includes the non-inverting input 264A coupled to voltage reference 266A and an output 268A. Output 268A of second amplifier 260A is coupled to an input of low pass filter 270A. The output from low pass filter 270A is coupled to the non-inverting input 272A of first amplifier 236A.

In voltage regulator 403, series regulator 210 performs the functions described above with respect to FIG. 2, by providing series regulation of the voltage input 202 to provide a regulated voltage output at output node 250. In addition, in a manner similar to that described above with respect to voltage regulator 230A of FIG. 2, in FIG. 4C the first amplifier 236A is operable to provide a control signal at output 237A to gate 238A to control semiconductor device 240A. In controlling semiconductor device 240A, control of the current flow (I_{PARALLEL}) 246A allows parallel regulator 261A to further regulate the voltage at output node 250, and to reduce or eliminate noise included in the voltage provided by series regulator 210 to output node 250. Voltage regulator 403 in various examples is also configured to provide the features and benefits described above related to second amplifier 260 and low pass filter 270 by incorporation of second amplifier 260A and low pass filter 270A.

FIG. 4D is a schematic diagram illustrating a voltage regulator 404 in accordance with one or more aspects of the present disclosure. The voltage regulator 404 is similar to the voltage regular 403 as shown in FIG. 4C, with the following differences. In voltage regulator 404, semiconductor device 240A comprises a P-type semiconductor device having a first lead 242A coupled to supply voltage (V_supply) 202A, and a second lead 244A coupled to node 231. In addition, in voltage regulator 404 the non-inverting input 272A of amplifier 236A is coupled to capacitor 232 and resistor 276A, and the inverting input 274A of amplifier 236A is coupled to receive the output from low pass filter 270A. Also the amplifier 260A has the non-inverting input 264A connected to the gate 238 while the inverting input 262A is connected to reference 266. In other respects, voltage regulator 404 operates as described above with respect to voltage regulator 403 shown in FIG. 4C, wherein amplifier 236A as shown in FIG. 4D is configured to receive in input from output node 250 through capacitor 232, and to provide a control signal at output 237A to regulate semiconductor device 240A. Control of semiconductor device 240A provides control of the current flow 246A, and thus allows parallel regulator 261A to further regulate the voltage at output node 250, and to reduce or eliminate noise included in the voltage provided by series regulator 210 to output node 250. Voltage regulator 404 in various examples is also configured to provide the features and benefits described above related to second amplifier 260 and low pass filter 270 by incorporation of second amplifier 260A and low pass filter 270A. Also the amplifier 260A has the non-inverting input connected to the gate 238A while the inverting input is connected to reference 266A.

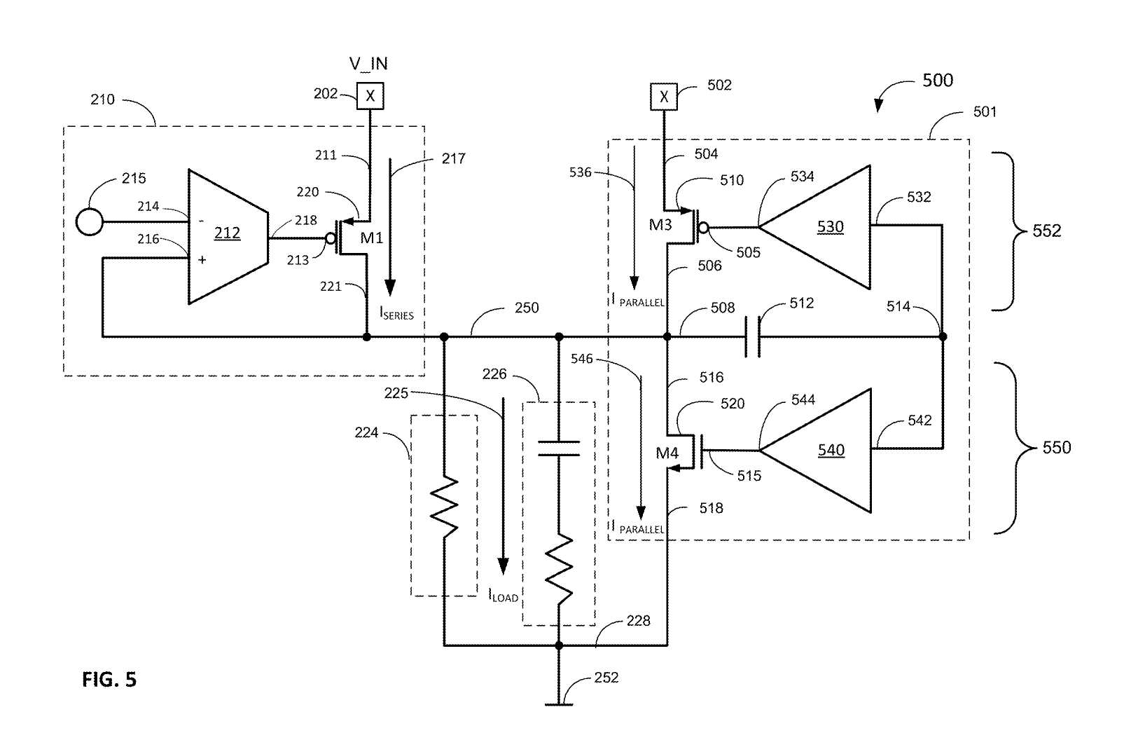

FIG. 5 is a schematic diagram illustrating a voltage regulator 500 in accordance with one or more aspects of the present disclosure. As illustrated in FIG. 5, elements that have been illustrated in previous figure(s) retain the same reference number used in the previous figure(s). As shown in FIG. 5, load 224, output capacitive element 226, and series regulator 210, including amplifier 212 and semiconductor device (M1) 220, are all coupled to output node 250 as illustrated and described above with respect to FIG. 2. As previously described for example with respect to FIG. 2, series regulator 210 is operable to provide voltage regulation to output node 250 and load 224 using the voltage provided by voltage input (V_IN) 202.

In addition, as illustrated in FIG. 5 voltage regulator 500 includes parallel regulator 501 coupled to output node 250. As illustrated, parallel regulator 501 includes capacitor 512, a P-type semiconductor device (M3) 510, and N-type semiconductor device (M4) 520, a first amplifier 530, and a second amplifier 540. Semiconductor device 510 includes a first lead 504 coupled to a supply voltage 502, and a second lead 506 coupled to node 508. In various examples, supply voltage 502 is the same voltage input 202 coupled to series regulator 210, although examples are not limited to having supply voltage 502 be the same supply voltage as voltage input 202. Semiconductor device 520 includes a first lead 516 coupled to node 508, and a second lead coupled to reference voltage 252. Capacitor 512 includes a first lead couple to node 508, wherein node 508 is coupled to output node 250. Capacitor 512 includes a second lead coupled to node 514. Node 514 is coupled to input 532 of first amplifier 530, and is also coupled to input 542 of second amplifier 540. Output 534 of first amplifier 530 is coupled to gate 505 of P-type semiconductor device 510, and output 544 of second amplifier 540 is coupled to gate 515 of N-type semiconductor device 520.

In operation, first amplifier 530 and second amplifier 540 provide output control signals that control the gates of semiconductor device 510 and semiconductor device 520, respectively, in a push-pull type arrangement. Capacitor 512 is coupled to output node 250, and thus is operable to couple variations in the voltage level provided at output node 250 as an input signal to the inputs of both first amplifier 530 and second amplifier 540. Based on this input signal, first amplifier 530 and second amplifier 540 are operable to control the biasing of semiconductor devices 510 and 520, respectively, and thus control a current flow 536 to source current to node 508, or a current flow 546 to sink current from node 508. First amplifier 530 provides a control signal from output 534 to the gate 505 of semiconductor device 510, controlling semiconductor device 510 to allow or not allow the current flow 536 from supply voltage 502 through semiconductor device 510 to be provided to node 508. Second amplifier 540 provides a control signal from output 544 to the gate 515 of semiconductor device 520, controlling semiconductor device 520 to allow or to not allow the current flow 546 to be sunk through semiconductor device 520 to reference voltage 252.

In various examples, a decrease in the voltage level at output node 250 is coupled through capacitor 512 to input 532 of first amplifier 530. In general, this decrease in voltage level results from a higher level of current flowing through the series regulator 210, thus, resulting in a larger voltage drop across semiconductor device 220. In some examples, this voltage decrease at output node 250 is a result of noise not completely removed by series regulator 210, and arriving at output node 250. In response to the decrease in the voltage level at output node 250, first amplifier 530 is operable to provide an output signal to bias the gate 505 of semiconductor device 510 so that semiconductor device 510 allows or increases a current flow 536 to source current from supply voltage 502 through semiconductor device 510 and to node 508, and thus to output node 250. This increase in current flow to output node 250 provides additional current to load 224 that therefore does not have to be provided from series regulator 210, and thus decreases the current flow 217 through semiconductor device 220 of series regulator 210. The decrease in current flow through semiconductor device 220 causes a smaller voltage drop to occur across semiconductor device 220, thus increasing the voltage level provided by series regulator 210 at output node 250. In effect, the decrease in voltage at output node 250 can be offset or eliminated by sourcing current flow 536, thus providing better voltage regulation at output node 250 relative to voltage decreases. In various examples, first amplifier 530 and semiconductor device 510 are operable to control an amount of control current flow 536, based on feedback received through capacitor 512, to source an amount of current needed to just offset the decrease in the voltage level being provided at output node 250. When no decrease in the voltage level is present at output node 250, first amplifier 530 and semiconductor device 510 are operable allow no current flow to node 508 through semiconductor device 510, and thus reduce the overall power consumption used by the portion of parallel regulator 501 comprising first amplifier 530 and semiconductor device 510. In various examples, during times when first amplifier 530 and semiconductor device 510 are allowing a current flow 546 to be sourced from supply voltage 502 through semiconductor device 510 to node 508, second amplifier 540 and semiconductor device 520 are operable to block any current flow from being sunk from node 508 through semiconductor deice 520, thus reducing the overall power consumption used by the portion of parallel regulator 501 comprising second amplifier 540 and semiconductor device 520.

In various examples, an increase in the voltage level at output node 250 is coupled through capacitor 512 to input 542 of second amplifier 540. In general, this increase in voltage level results from a lower level of current flowing through the series regulator 210, thus resulting in a smaller voltage drop across semiconductor device 220. In some examples, this voltage increase at output node 250 is a result of noise not completely removed by series regulator 210, and arriving at output node 250. In response to the increase in voltage level at output node 250, second amplifier 540 is operable to provide an output signal to bias the gate 515 of semiconductor device 520 so that semiconductor device 520 allows or increases a current flow 546 to sink current from node 508, and thus from output node 250, to reference voltage 252. This increase in current flow from output node 250 is in addition to any current provided to load 224, and thus increases the current flow 217 through semiconductor device 220 of series regulator 210. The increase current flow 217 through semiconductor device 220 causes a larger voltage drop to occur across semiconductor device 220, thus reducing the voltage level provided by series regulator 210 at output node 250. In effect, the increase in voltage at output node 250 can be offset or eliminated by sinking current flow 546, thus providing better voltage regulation at output node 250 relative to voltage increases. In various examples, second amplifier 540 and semiconductor device 520 are operable to control the amount of current flow 546, based on feedback received through capacitor 512, to sink an amount of current needed to just offset the increase in the voltage level being provided at output node 250. When no increase in the voltage level is present at output node 250, second amplifier 540 and semiconductor device 520 are operable allow no current flow from node 508 through semiconductor device 520, and thus reduce the overall power consumption used by the portion of parallel regulator 501 comprising second amplifier 540 and semiconductor device 520. In various examples, during times when second amplifier 540 and semiconductor device 520 are allowing a current flow 546 to be sunk from node 508 to reference voltage 252, first amplifier 530 and semiconductor device 510 are operable to block any current flow from supply voltage 502 through semiconductor deice 510, thus reducing the overall power consumption used by the portion of parallel regulator 501 comprising first amplifier 530 and semiconductor device 510.

In various examples, when no changes relative to the voltage level at output node 250 are occurring, both first amplifier 530 and second amplifier 540 are operable to control semiconductor devices 510 and 520, respectively, so that no current is sourced to node 508, and no current is sunk from node 508. Thus, parallel regulator 501, when used in conjunction with a series regulator, such as but not limed to series regulator 210, provides flexibility and reduced current consumption when operating as a parallel regulator.

The parallel regulator circuits as shown in FIG. 5 as comprising parallel regulator 501 are not limited to any particular circuits, or types of devices. In various examples, the parallel regulator, generally referred to by bracket 550 in FIG. 5 comprising second amplifier 540 and semiconductor device 520, can comprise parallel regulator 230 as shown in FIG. 2, or voltage regulator 261 as shown in FIG. 4A or as shown in FIG. 4B. In various examples, the parallel regulator, generally referred to by bracket 552 in FIG. 5 and comprising first amplifier 530 and semiconductor device 510, can comprise voltage regulator 230A as shown in FIG. 2, or voltage regulator 261A as shown in FIG. 4C or as shown in FIG. 4D. In various examples, semiconductor devices 510 and 520 are a same type device, e.g. are both P-type semiconductor devices or are both N-type semiconductor devices. In other examples, semiconductor device 510 is one type of semiconductor device (P or N type) and semiconductor device 520 is the other type of semiconductor device.

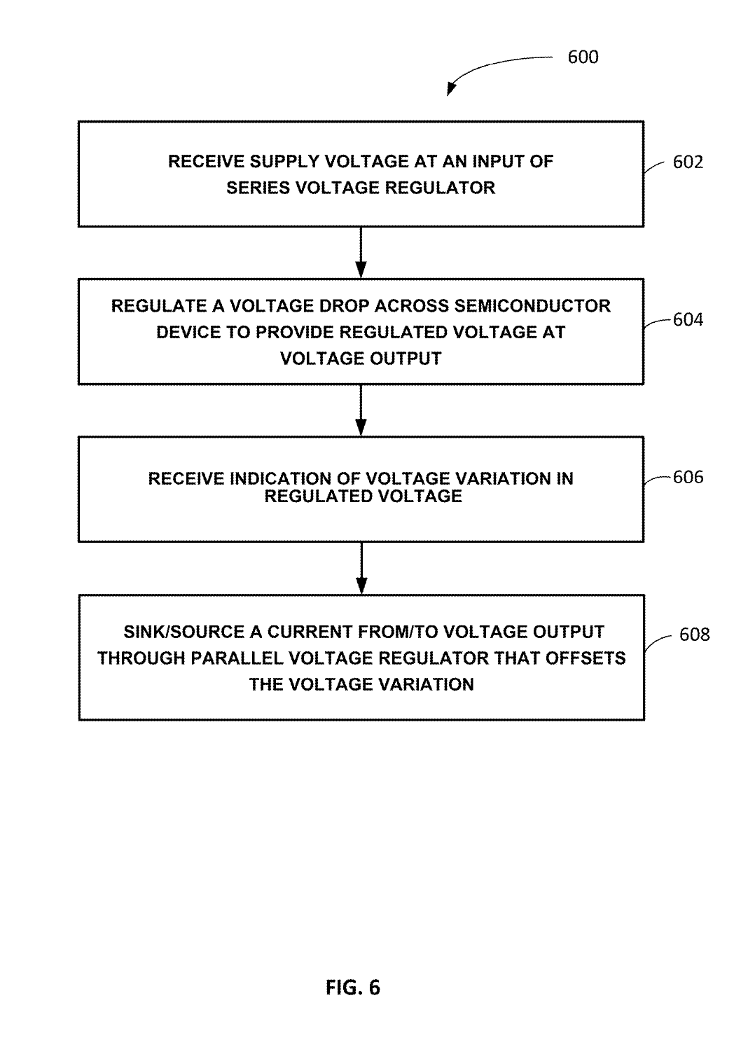

FIG. 6 is a flowchart illustrating example methods 600 in accordance with one or more aspects of the present disclosure. Although discussed with respect to voltage regulators 200, 401, 402, 403, 404, and 500 as illustrated and described with respect to FIG. 2, FIGS. 4A-D, and FIG. 5 respectively, the example methods 600 are not limited to the example implementations illustrated with respect to these voltage regulators and figures.

As illustrated in the example method of FIG. 6, a voltage regulator 200 receives a supply voltage at an input of a series regulator 210 (block 602). Voltage regulator 200 regulates a voltage drop across a semiconductor device 220 to provide a regulated voltage output at a output node 250 of the series regulator 210 (block 604). Voltage regulator 200 receives an indication of a voltage variation in the regulated voltage output (block 606). In response to the variation in the regulated voltage output, voltage regulator 200 sinks a current from the voltage output through a parallel voltage regulator in an amount that offsets the voltage variation at the voltage output (block 608).

Voltage regulator 200 comprises receiving the indication of a voltage variation at the parallel regulator 230 through a capacitor 232. When sinking the current from the output node 250 through the parallel regulator 230, voltage regulator 200 receives an input signal indicative of the variation in the voltage level provided at the voltage output, generates an output signal based in the input signal, biases a gate of a semiconductor device using the output signal to allow an amount of current sunk from the voltage output to flow thorough the semiconductor device. In various examples, voltage regulator 200 generates a reference voltage level, and provided the reference voltage level to the gate of the semiconductor device to bias the semiconductor device.

In various examples, one of voltage regulators 401, 402, 403, or 404 provide the reference voltage level to the gate 238 of the semiconductor device 240 by filtering the reference voltage level through a low pass filter 270. In various examples, the voltage regulator provides the reference voltage level to the gate 238 of the semiconductor device 240 to bias the semiconductor device by setting the bias to a threshold voltage level for the semiconductor device. In various examples, voltage regulator 501 sinks a current 546 from the output node 250 in response to the variation in the regulated voltage output when the variation in the regulated output comprises an increase in the regulated output voltage, and sources a current 536 to the voltage output in response to the variation in the regulated voltage output when the variation in the regulated output comprises a decrease in the regulated output voltage.

The techniques described herein may be implemented in hardware, firmware, or any combination thereof. Any features described as modules, units, circuits, devices, or components may be implemented together in an integrated logic device or separately as discrete but interoperable logic devices. In some cases, various features may be implemented as an integrated circuit device, such as an integrated circuit chip or chipset. If implemented in software, the techniques may be realized at least in part by a computer-readable storage medium comprising instructions that, when executed, cause a processor to perform one or more of the techniques described above.

A semiconductor or semiconductor device as described herein generally refers to a transistor (3-lead device) as would be understood by one of ordinary skill in the art. Semiconductor and semiconductor device as used herein is not limited to any particular type of transistor, and any transistor operable to provide the functions of the semiconductor devices described herein, and the equivalents thereof, can be used in these devices and systems. In various examples, a semiconductor or semiconductor device as used herein refers to a Metal-Oxide Semiconductor (MOS) device, a Metal-Oxide-Semiconductor Field Effect Transistor (MOSFET) device, or a Complementary Metal-Oxide Semiconductor (CMOS) device. An amplifier as described herein is not limited to any particular type of amplifier, and any amplifier operable to provide the functions of the amplifier(s) described herein, and the equivalents thereof, can be used in these devices and systems. In some examples, an “amplifier” as described herein is implemented as an integrated circuit. In some examples, an “amplifier” as described herein is an operational amplifier. In various examples, a plurality of amplifiers as described herein for a given voltage regulator are fabricated on a common integrated circuit to promote matching of the performance characteristics between the amplifiers.

In various examples, use of the word “coupled” or “coupling” refers to a direct coupling between lead or terminals of a device or electrical component by a conductor without intervening devices or electrical components, as would be understood by a person of ordinary skill in the art. In various examples, use of the word “coupled” or “coupling” refers to electrical coupling of devices or electrical components that may include coupling through one or more intervening devices or other electrical components, as would be understood by one of ordinary skill in the art.

The following examples describe one or more aspects of the disclosure.

### EXAMPLE 1

A circuit comprising: a series voltage regulator comprising a first semiconductor device coupled in series between a supply voltage and a voltage output, the series regulator operable to receive a voltage level from the supply voltage and to provide a regulated voltage level at the voltage output; and a parallel voltage regulator comprising a second semiconductor device coupled to the voltage output, the parallel voltage regulator operable to detect a variation in a voltage level provided at the voltage output, and to sink a current from the voltage output through the semiconductor device, an amount of current sunk adequate to offset the change in the voltage level at the voltage output.

### EXAMPLE 2

The circuit of example 1, wherein the parallel voltage regulator is coupled to the voltage output through a capacitor.

### EXAMPLE 3

The circuit of either of examples 1 or 2, wherein the parallel voltage regulator further comprises: an amplifier comprising an first input coupled to the voltage output and an output coupled to a gate of the second semiconductor device, the amplifier operable to receive an input signal at the input indicative of the level of variation in the voltage level provided at the voltage output, and to generate an output signal that when provided to the gate of the second semiconductor device, allows the amount of current to be sunk from the voltage output that is adequate to offset the change in the voltage level at the voltage output.

### EXAMPLE 4

The circuit of any of examples 1 to 3, wherein the parallel voltage regulator further comprises: a biasing amplifier coupled to the amplifier, the biasing amplifier operable to generate a reference voltage level, and to provide the reference voltage level to a second input of the amplifier, the amplifier operable to provide the reference voltage level to the gate of the second semiconductor device to provide a DC bias to the second semiconductor device.

### EXAMPLE 5

The circuit of any of examples 1 to 4, further comprising: a low pass filter coupled to an output of the biasing amplifier, the low pass filter operable to provide low pass filtering to the reference voltage level generated by the biasing amplifier.

### EXAMPLE 6

The circuit of any of examples 1 to 5, wherein the DC bias is set to threshold voltage level for the second semiconductor device.

### EXAMPLE 7

The circuit of any of examples 1 to 6, wherein the voltage output is operable to be coupled to one or more loads, and wherein when providing a current load of 1 ampere at 3.3 volts to the one or more loads, the amount of current sunk from the voltage output through the semiconductor device does not exceed 5 milliamps.

### EXAMPLE 8

The circuit of any of examples 1 to 7, wherein the circuit is operable to receive the supply voltage from a DC/DC switching power converter.

### EXAMPLE 9

The circuit of any of examples 1 to 8, wherein the series voltage regulator is a low-drop out (LDO) voltage regulator.

### EXAMPLE 10

The circuit of any of examples 1 to 9, wherein the circuit has an efficiency of at least 82 percent.

### EXAMPLE 11

The circuit of examples 1 to 10, wherein the semiconductor device comprises a Metal-Oxide Semiconductor (MOS) device.

### EXAMPLE 12

A method comprising: receiving a supply voltage at an input of a series voltage regulator; regulating a voltage drop across a semiconductor device to provide a regulated voltage output at a voltage output of the series voltage regulator; receiving an indication of a voltage variation in the regulated voltage output; and in response to the variation in the regulated voltage output, sinking a current from the voltage output through a parallel voltage regulator in an amount that offsets the voltage variation at the voltage output.

### EXAMPLE 13

The method of example 12, wherein receiving the indication of a voltage variation includes coupling the regulated voltage output to the parallel voltage regulator through a capacitor.

### EXAMPLE 14

The method of either of examples 12 or 13, wherein sinking the current from the voltage output through the parallel voltage regulator comprises: receiving an input signal indicative of the variation in the voltage level provided at the voltage output; generating an output signal based in the input signal; and biasing a gate of a semiconductor device using the output signal to allow the amount of current sunk from the voltage output to flow thorough the semiconductor device.

### EXAMPLE 15

The method of any of examples 12 to 14, further comprising: generating a reference voltage level; and providing the reference voltage level to the gate of the semiconductor device to bias the semiconductor device.

### EXAMPLE 16

The method of any of examples 12 to 15, wherein providing the reference voltage level to the gate of the semiconductor device comprises filtering the reference voltage level through a low pass filter.

### EXAMPLE 17

The method of an of examples 12 to 16, wherein the providing the reference voltage level to the gate of the semiconductor device to bias the semiconductor device comprises setting the bias to a threshold voltage level for the semiconductor device.

### EXAMPLE 18

The method of any of examples 12 to 17, further comprising: sinking a current from the voltage output in response to the variation in the regulated voltage output when the variation in the regulated output comprises an increase in the regulated output voltage; and sourcing a current to the voltage output in response to the variation in the regulated voltage output when the variation in the regulated output comprises a decrease in the regulated output voltage.

### EXAMPLE 19

A circuit comprising: a series voltage regulator comprising a first semiconductor device coupled in series between a supply voltage and a voltage output, the series regulator operable to receive a voltage level from the supply voltage and to provide a regulated voltage level at the voltage output; and a parallel regulator comprising a second semiconductor device coupled to the voltage output and a third semiconductor device coupled to the voltage output, wherein the parallel regulator is operable to detect an increase in voltage level provided at the voltage output, and in response to the increase in the voltage level, to source a first amount of current to the voltage output through the second semiconductor device, the first amount of current adequate to offset the increase in the voltage level at the voltage output, and wherein the parallel regulator is operable to detect a decrease in voltage level provided at the voltage output, and in response to the decrease in the voltage level, to sink a second amount of current from the voltage output through the third semiconductor device, the second amount of current adequate to offset the decrease in the voltage level at the voltage output.

### EXAMPLE 20

The circuit of example 19, wherein the parallel regulator further comprises: a first amplifier coupled to a gate of the second semiconductor device, the first amplifier operable to receive a signal indicative of the decrease in the voltage level provided at the voltage output, and to provide an output to the gate of the second semiconductor device to regulate the second semiconductor device so that the first amount of current flows through the second semiconductor device and is sourced to the voltage output; and a second amplifier coupled to a gate of the third semiconductor device, the second amplifier operable to receive a signal indicative of the increase in the voltage level provided at the voltage output, and to provide an output to the gate of the third semiconductor device to regulate the third semiconductor device so that the second amount of current flows through the third semiconductor device and is sunk from the voltage output.

Various examples have been described. These and other examples are within the scope of the following claims.

What is claimed is:

1. A circuit comprising:
a series voltage regulator comprising a first semiconductor device coupled in series between a supply voltage and a voltage output, the series regulator operable to receive a voltage level from the supply voltage and to provide a regulated voltage level at the voltage output; and
a parallel voltage regulator comprising a second semiconductor device coupled to the voltage output, the parallel voltage regulator operable to detect a variation in a voltage level provided at the voltage output, and to sink a current from the voltage output through the semiconductor device, an amount of current sunk adequate to offset the change in the voltage level at the voltage output.

2. The circuit of claim 1, wherein the parallel voltage regulator is coupled to the voltage output through a capacitor.

3. The circuit of claim 1, wherein the parallel voltage regulator further comprises:
an amplifier comprising an first input coupled to the voltage output and an output coupled to a gate of the second semiconductor device, the amplifier operable to receive an input signal at the input indicative of the level of variation in the voltage level provided at the voltage output, and to generate an output signal that when provided to the gate of the second semiconductor device, allows the amount of current to be sunk from the voltage output that is adequate to offset the change in the voltage level at the voltage output.

4. The circuit of claim 3, wherein the parallel voltage regulator further comprises:
a biasing amplifier coupled to the amplifier, the biasing amplifier operable to generate a reference voltage level, and to provide the reference voltage level to a second input of the amplifier, the amplifier operable to provide the reference voltage level to the gate of the second semiconductor device to provide a DC bias to the second semiconductor device.

5. The circuit of claim 4, further comprising:
a low pass filter coupled to an output of the biasing amplifier, the low pass filter operable to provide low pass filtering to the reference voltage level generated by the biasing amplifier.

6. The circuit of claim 4, wherein the DC bias is set to threshold voltage level for the second semiconductor device.

7. The circuit of claim 1, wherein the voltage output is operable to be coupled to one or more loads, and wherein when providing a current load of 1 ampere at 3.3 volts to the one or more loads, the amount of current sunk from the voltage output through the semiconductor device does not exceed 5 milliamps.

8. The circuit of claim 1, wherein the circuit is operable to receive the supply voltage from a DC/DC switching power converter.

9. The circuit of claim 1, wherein the series voltage regulator is a low-drop out (LDO) voltage regulator.

10. The circuit of claim 1, wherein the circuit has an efficiency of at least 82 percent.

11. The circuit of claim 1, wherein the semiconductor device comprises a Metal-Oxide Semiconductor (MOS) device.

12. A method comprising:
receiving a supply voltage at an input of a series voltage regulator;
regulating a voltage drop across a semiconductor device to provide a regulated voltage output at a voltage output of the series voltage regulator;
receiving an indication of a voltage variation in the regulated voltage output; and
in response to the variation in the regulated voltage output, sinking a current from the voltage output through a parallel voltage regulator in an amount that offsets the voltage variation at the voltage output.

13. The method of claim 12, wherein receiving the indication of a voltage variation includes coupling the regulated voltage output to the parallel voltage regulator through a capacitor.

14. The method of claim 12, wherein sinking the current from the voltage output through the parallel voltage regulator comprises:
receiving an input signal indicative of the variation in the voltage level provided at the voltage output;
generating an output signal based in the input signal; and
biasing a gate of the semiconductor device using the output signal to allow an amount of current sunk from the voltage output to flow thorough the semiconductor device.

15. The method of claim 14, further comprising:
generating a reference voltage level; and
providing the reference voltage level to the gate of the semiconductor device to bias the semiconductor device.

16. The method of claim 15, wherein providing the reference voltage level to the gate of the semiconductor device comprises filtering the reference voltage level through a low pass filter.

17. The method of claim 15, wherein the providing the reference voltage level to the gate of the semiconductor device to bias the semiconductor device comprises setting the bias to a threshold voltage level for the semiconductor device.

18. The method of claim 12, further comprising:
sinking a current from the voltage output in response to the variation in the regulated voltage output when the variation in the regulated output comprises an increase in the regulated output voltage; and
sourcing a current to the voltage output in response to the variation in the regulated voltage output when the variation in the regulated output comprises a decrease in the regulated output voltage.

19. A circuit comprising:
a series voltage regulator comprising a first semiconductor device coupled in series between a supply voltage and a voltage output, the series regulator operable to receive a voltage level from the supply voltage and to provide a regulated voltage level at the voltage output; and
a parallel regulator comprising a second semiconductor device coupled to the voltage output and a third semiconductor device coupled to the voltage output,
wherein the parallel regulator is operable to detect a decrease in voltage level provided at the voltage output, and in response to the decrease in the voltage level, to source a first amount of current to the voltage output through the second semiconductor device, the first amount of current adequate to offset the decrease in the voltage level at the voltage output, and
wherein the parallel regulator is operable to detect an increase in voltage level provided at the voltage output, and in response to the increase in the voltage level, to sink a second amount of current from the voltage output through the third semiconductor device, the second amount of current adequate to offset the increase in the voltage level at the voltage output.

20. The circuit of claim 19, wherein the parallel regulator further comprises:
a first amplifier coupled to a gate of the second semiconductor device, the first amplifier operable to receive a signal indicative of the decrease in the voltage level provided at the voltage output, and to provide an output to the gate of the second semiconductor device to regulate the second semiconductor device so that the first amount of current flows through the second semiconductor device and is sourced to the voltage output; and
a second amplifier coupled to a gate of the third semiconductor device, the second amplifier operable to receive a signal indicative of the increase in the voltage level provided at the voltage output, and to provide an output to the gate of the third semiconductor device to regulate the third semiconductor device so that the second amount of current flows through the third semiconductor device and is sunk from the voltage output.
